(19) United States
(12) Patent Application Publication
(10) Pub. No.: US 2005/0073733 A1
(43) Pub. Date: Apr. 7, 2005

(54) Image forming method and apparatus

(76) Inventor: Yun-su Kim, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/929,472

(22) Filed: Aug. 31, 2004

(30) Foreign Application Priority Data
Oct. 7, 2003 (KR) 2003-69722

(51) Int. Cl. H04N 1/04; G06F 15/00

(52) U.S. Cl. 358/528; 358/474

(57) ABSTRACT

An image forming apparatus having a scanning function and an image forming method by which images of right and left pages of a book are not printed upside down when the book is scanned using the image forming apparatus. According to the image forming method, the host receives scanned image data from the image forming apparatus and stores the scanned image data. A control unit of the host determines whether a scanned image belongs to a left page or a right page of a book, and if the scanned image belongs to a right page, the scanned image is rotated 180° and the rotated image is stored in the host.

### CROSS-REFERENCE TO RELATED APPLICATIONS

This application claims the benefit under 35 U.S.C. §119(a) of Korean Patent Application No. 2003-69722, filed in the Korean Intellectual Property Office on Oct. 7, 2003, the entire contents of which are incorporated herein by reference.

### BACKGROUND OF THE INVENTION

1. Field of the Invention

The present invention relates to an image forming apparatus and method. More particularly, the present invention relates to an image forming apparatus having a scanning function and an image forming method by which scanned images of left and right pages of a book are not printed upside down when the book is scanned using the image forming apparatus.

2. Description of the Related Art

FIG. 1 illustrates a flatbed-type image forming apparatus 100 that includes an image scanning side 106, an original fixing side 104, and a cover 102.

FIG. 2 is schematic view showing the scanning of a book 110 by using the flatbed-type image forming apparatus 100 of FIG. 1.

As shown in FIG. 2, when the book 110 is scanned using the flatbed-type image forming apparatus 100 having a scanning function, the book 110 has to be rotated 180° to scan a right page of the book 110 after a left page of the book 110 has been scanned. In this case, a scanned image of the left page is displayed properly on a monitor of a PC, but a scanned image of the right page is displayed upside down on the monitor of the PC. Thus, to display the scanned image of the right page properly, a user has to rotate the scanned image of the right page 180° using a predetermined image processing function. Such a process is time consuming and causes inconvenience to the user.

U.S. Pat. No. 6,243,549 issued to Eiichi Ando entitled “Image Forming Apparatus For Forming A Plurality Page Images Formed On One Side Of A Sheet On Both Sides Of A Sheet”, the entire contents of which are incorporated herein by reference, discloses a conventional image forming apparatus for forming a plurality of page images on one side or both sides of a sheet of paper. The conventional image forming apparatus allows a user to see and read a plurality of printed sheets, like pages of a book, but does not suggest any solution to the upside-down images.

Accordingly, a need exists for a system and method to display and/or save scanned images in a correct and consistent orientation, such that the images are easily and correctly printed, viewed and saved.

### SUMMARY OF THE INVENTION

Accordingly, the present invention solves the above and other problems by providing an image forming method and an image forming apparatus by which scanned images are not printed upside down when a book to be scanned has to be rotated (for example, 180°) in the image forming apparatus.

The present invention also provides a host connected to the image forming apparatus in which, scanned images obtained using the image forming apparatus are not saved upside down.

According to one object of the present invention, an image forming method is provided and performed by an image forming apparatus having a scanning function and connected to a host. In the image forming method, the host receives scanned image data from the image forming apparatus and stores the scanned image data. A control unit of the host then determines whether a scanned image belongs to a left page or a right page of a book, and the scanned image is rotated (for example, 180°) and stored if the scanned image belongs to the right page.

According to another object of the present invention, an image forming method is provided and performed by an image forming apparatus having a scanning function and connected to a host. In the image forming method, the image forming apparatus scans an image and stores the scanned image. A control unit of the image forming apparatus then determines whether the scanned image belongs to a left page or a right page of a book, and the scanned image is rotated (for example, 180°) and the rotated image is stored if the scanned image belongs to the right page.

According to still another object of the present invention, a host is provided and connected to an image forming apparatus having a scanning function, the host comprising a scanner driving unit, a memory unit, and a control unit. The scanner driving unit receives scanned image data from the image forming apparatus. The memory unit then stores the scanned image data. The control unit determines whether a scanned image belongs to a left page or a right page of a book and rotates the scanned image (for example, 180°) and stores the rotated image in the memory unit if the scanned image belongs to a right page.

According to yet another object of the present invention, an image forming apparatus is provided having a scanning function, connected to a host, and comprising a scanning unit, a memory unit, and a control unit. The scanning unit scans an image. The memory unit then stores scanned image data. The control unit determines whether a scanned image belongs to a left page or a right page of a book and rotates the scanned image (for example, 180°) and stores the rotated image in the memory unit if the scanned image belongs to the right page.

### BRIEF DESCRIPTION OF THE DRAWINGS

The above and other aspects and advantages of the present invention will become more apparent by describing in detail exemplary embodiments thereof with reference to the attached drawings in which:

FIG. 1 illustrates a flatbed-type image forming apparatus;

FIG. 2 is a schematic view showing the scanning of a book using the flatbed-type image forming apparatus of FIG. 1;

FIG. 3 is a block diagram of an image forming apparatus and a host computer according to an exemplary embodiment of the present invention;

FIG. 4 illustrates a book scanning mode in the host computer according to an exemplary embodiment of the present invention;

FIG. 5A illustrates light emitting diodes (LEDs) and keys of the image forming apparatus according to an exemplary embodiment of the present invention;

FIG. 5B illustrates a liquid crystal display (LCD) and keys of the image forming apparatus according to an exemplary embodiment of the present invention;

FIG. 6 is a flowchart of an image forming method according to a first embodiment of the present invention; and

FIG. 7 is a flowchart of an image forming method according to a second embodiment of the present invention.

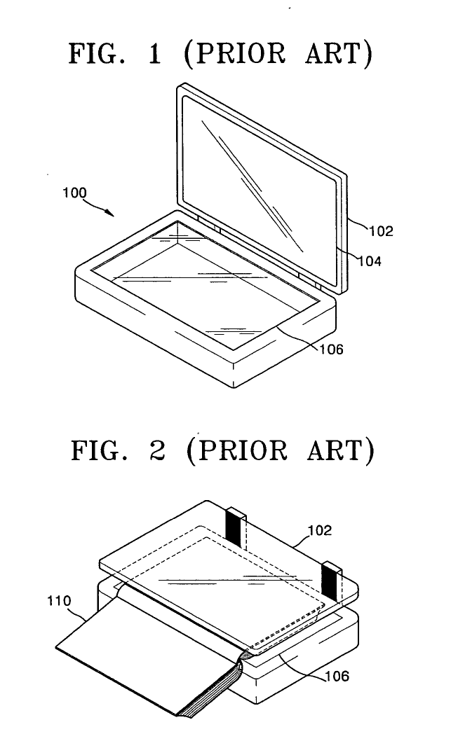

Throughout the drawings, like reference numerals will be understood to refer to like parts, components or structures.

### DETAILED DESCRIPTION OF THE EXEMPLARY EMBODIMENTS

The present invention will now be described in greater detail with reference to the accompanying drawings, in which embodiments of the invention are shown.

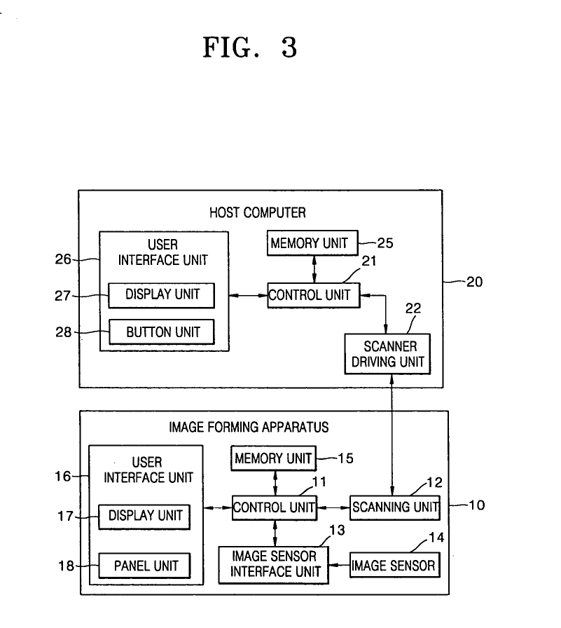

FIG. 3 is a block diagram of an image forming apparatus 10 and a host computer 20, according to an exemplary embodiment of the present invention.

The image forming apparatus 10 includes a control unit 11, a scanning unit 12, an image sensor interface unit 13, an image sensor 14, a memory unit 15, and a user interface unit 16. The user interface unit 16 includes a display unit 17 and a panel unit 18.

The control unit 11 controls the image forming apparatus 10 according to a predetermined program. The image forming apparatus 10 can be any number of devices, such as a scanner or a multifunction device. The multifunction device has functions of a scanner, a printer, and a copier. The control unit 11 determines an image orientation issue, for example (but not limited to), whether a scanned image belongs to a left page or a right page of a book. If the scanned image belongs to the right page of the book, the control unit 11 rotates the scanned image (for example, 180°) and stores the rotated image in the memory unit 15. For this example, it can be assumed that the scanned image of the left page would be conventionally displayed properly on a monitor (not shown) of the host computer 20, and the scanned image of the right page would be conventionally displayed upside down.

The memory unit 15 stores scanned image data, an operating program, and a general control program of the control unit 10 according to the execution of the operating program and the general control program of the control unit 10.

The image sensor interface unit 13 adjusts a signal of the image sensor 14 and obtains image data that is transmitted to the control unit 11.

The scanning unit 12 receives a scanning command from the host computer 20 and transmits the image data stored in the memory unit 15 to the host computer 20.

The display unit 17 includes a first LED (for example, 41 of FIG. 5A) and a second LED (for example, 43 of FIG. 5A), or an LCD (for example, 50 of FIG. 5B). The first LED 41 indicates whether a book scanning mode is activated. For example, if the first LED 41 is turned on, the book scanning mode is activated, and if the first LED 41 is turned off, the book scanning mode is deactivated. The second LED 43 indicates whether a next page to be scanned is a left page or a right page. For example, if the second LED 43 is turned on, the left page is to be scanned, and if the second LED 43 is turned off, the right page is to be scanned. The LCD 50 of FIG. 5B can have functions of both the first LED 41 and the second LED 43.

The panel unit 18 includes keys (for example, 42 and 44 of FIG. 5A), or keys (for example, 52 and 54 of FIG. 5B). By using the keys 42 or 52, activation of the book scanning mode can be determined. The control unit 11 rotates the scanned image of the right page 180° and stores the rotated image only when the book scanning mode is activated. By using the keys 44 or 54, a start page can be set to either represent a left page or a right page. Also, through the use of keys 44 or 54, a next page to be scanned can be reset to represent either a left page or a right page. For example, if a page does not need to be scanned or a page to be scanned is an empty page, resetting may be required.

Referring again to FIG. 3, the host computer 20 is connected to the image forming apparatus 10. The host computer 20 includes a control unit 21, a scanner driving unit 22, a memory unit 25, and a user interface unit 26. The user interface unit 26 includes a display unit 27 and a button unit 28.

The scanner driving unit 22 receives the scanned image data from the scanning unit 12 of the image forming apparatus 10. The memory unit 25 stores the scanned image data. The control unit 21 determines whether the scanned image belongs to a left page or a right page. If the scanned image belongs to the right page, the control unit 21 rotates the scanned image 180° and stores the rotated image in the memory unit 25.

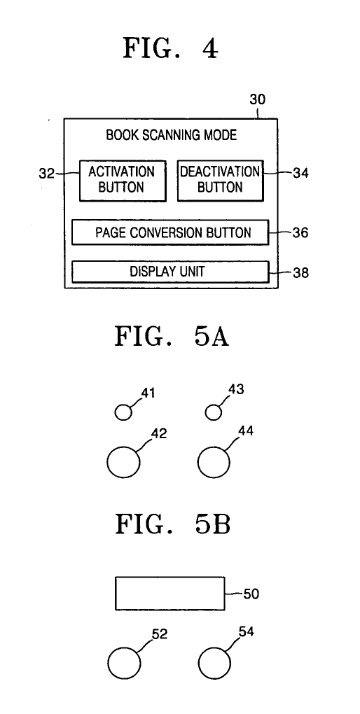

The user interface unit 26 is described in greater detail below with reference to FIG. 4. FIG. 4 shows an example dialogue box 30 that illustrates the book scanning mode in the host computer 20 of FIG. 3.

The dialogue box 30 includes an activation button 32 and a deactivation button 34 for activating or deactivating the book scanning mode. Here, the control unit 21 rotates the scanned image of the right page 180° and then stores the rotated image only when the book scanning mode is activated.

The dialogue box 30 also includes a page conversion button 36, wherein the start page can be set to a left page or a right page using the page conversion button 36. Also, the next page to be scanned can be reset to a left page or a right page using the page conversion button 36. For example, if a next page does not need to be scanned or a page to be scanned is empty, resetting may be required.

The dialogue box 30 also includes a display unit 38 that indicates whether the next page to be scanned is a left page or a right page. Thus, a user can refer to the next page to be scanned that is indicated by the display unit 38, or can reset the next page to be scanned to a left page or a right page, if necessary.

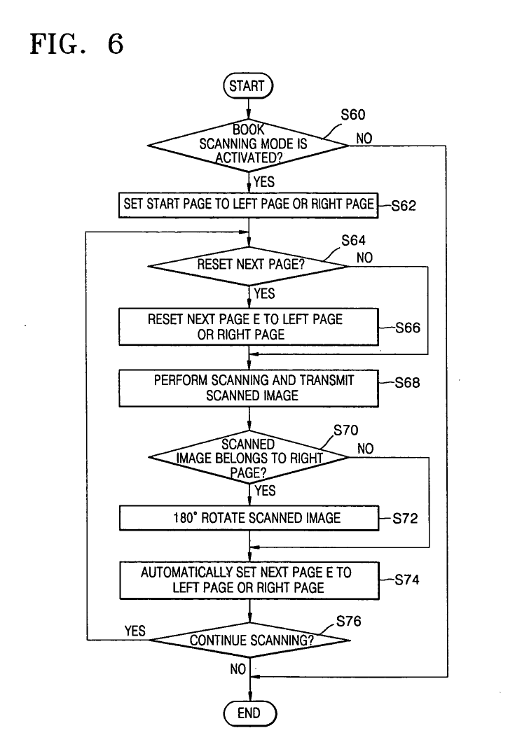

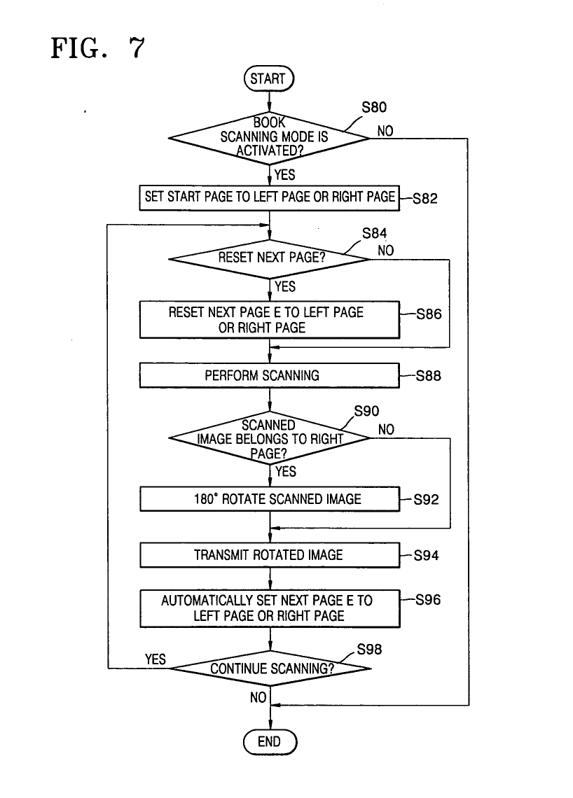

FIG. 6 is a flowchart of an image forming method according to a first embodiment of the present invention, and FIG. 7 is a flowchart of an image forming method according to a second embodiment of the present invention.

According to the image forming method of FIG. 6, a control unit (for example, 21 of FIG. 3) of a host computer (for example, 20 of FIG. 3) rotates a scanned image of a right page 180° and stores the rotated image in a memory unit (for example, 25 of FIG. 3). In contrast, according to the image forming method of FIG. 7, a control unit (for example, 11 of FIG. 3) of an image forming apparatus (for example, 10 of FIG. 3) rotates a scanned image of a right page 180°, stores the rotated image in a memory unit (for example, 15 of FIG. 3), and then transmits the stored image to the host computer (for example, 20 of FIG. 3).

Referring to FIG. 6, the image forming method according to the first embodiment of the present invention will be described.

In step S60, a control unit (for example, 21 of FIG. 3) of a host computer (for example, 20 of FIG. 3) determines whether to activate a book scanning mode. If the book scanning mode is deactivated, the process is terminated. If the book scanning mode is activated, the process proceeds to step S62. In step S62, a start page is set to either a left page or a right page by using a button unit (for example, 28 of FIG. 3) of the host computer.

In step S64, it is then determined whether to reset a next page to be scanned to either a left page or a right page. For example, if a next page does not need to be scanned or a page to be scanned is empty, resetting may be required. If resetting is required, the process proceeds to step S66. In step S66, the next page to be scanned is reset to either a left page or a right page and the process proceeds to step S68. If resetting is not required in step S64, the process also proceeds to step S68. In step S68, scanning is performed by an image forming apparatus (for example, 10 of FIG. 3) and scanned image data is transmitted to the host computer. The host computer receives the scanned image data from the image forming apparatus and stores the received scanned image data in a memory unit (for example, 25 of FIG. 3).

In step S70, it is then determined whether the scanned image belongs to either a left page or a right page. If the scanned image belongs to a left page, the process proceeds to step S74. If the scanned image belongs to a right page, the process proceeds to step S72. In step S72, the scanned image is rotated 180° and stored. Thus, the scanned image of a right page is not upside down when subsequently viewed.

In step S74, the control unit of the host computer automatically sets the next page to be scanned to either a left page or a right page based on a current page. For example, if the current page is a left page, the next page to be scanned is set to a right page. As such, since the next page to be scanned is automatically set after the scanned image of the current page is created, the user can scan the next page more quickly and conveniently.

In step S76, it is determined whether to continue scanning a book. If the book will be continuously scanned, the process proceeds to step S64. If the book will not be continuously scanned, the process is terminated.

Hereinafter, the image forming method according to the second embodiment of the present invention will be described in greater detail with reference to FIG. 7.

In step S80, a control unit (for example, 11 of FIG. 3) of an image forming apparatus (for example, 10 of FIG. 3) determines whether the book scanning mode is activated. If the book scanning mode is deactivated, the process is terminated. If the book scanning mode is activated, the process proceeds to step S82. In step S82, a start page is set to either a left page or a right page by using a panel unit (for example, 18 of FIG. 3) of the image forming apparatus.

In step S84, it is then determined whether to reset the next page to be scanned to either a left page or a right page. For example, if a next page does not need to be scanned or a page to be scanned is empty, resetting may be required. If resetting is required, the process proceeds to step S86. After the next page to be scanned is reset to a left page or a right page in step S86, the process proceeds to step S88. If resetting is not required in step S84, the process also proceeds to step S88. In step S88, the image forming apparatus performs a scanning operation.

In step S90, a control unit (for example, 11 of FIG. 3) of the image forming apparatus determines whether the scanned image belongs to either a left page or a right page. If the scanned image belongs to a left page, the process proceeds to step S94. If the scanned image belongs to a right page, the process proceeds to step S92. In step S92, the scanned image is rotated 180° and stored. Thus, the scanned image of a right page is not upside down when subsequently viewed. In step S94, the stored image data is transmitted to a host computer.

In step S96, the control unit of the image forming apparatus automatically resets the next page to be scanned to either a left page or a right page. For example, if a current page is a left page, the next page to be scanned is set to a right page. As such, since the next page to be scanned is automatically set after the scanned image of the current page is created, the user can quickly and conveniently scan the next page.

In step S98, it is then determined whether to continue scanning a book. If the book will be continuously scanned, the process proceeds to step S84. If the book will not be continuously scanned, the process is terminated.

According to the image forming method of FIG. 7, after a scanned image is stored in the memory unit of the image forming apparatus, the scanned image of the right page is rotated 180° and stored in the memory unit. Alternatively, before a scanned image is stored in the memory unit of the image forming apparatus, it can be determined whether the scanned image belongs to a right page. If the scanned image belongs to a right page, the scanned image can be stored in the opposite order in the memory unit of the image forming apparatus. In doing so, the same effects as the above-described effects can be obtained.

As described in the above exemplary embodiments of the present invention, it is possible to obtain a scanned image that is not upside down in a flatbed-type image forming apparatus. Thus, a user does not need to rotate the scanned image by using a predetermined image processing function, thereby avoiding a time-consuming process and related inconveniences.

Also, since the next page to be scanned is automatically reset to either a left page or a right page after a current page is scanned, the user can quickly and conveniently continue to scan the next page.

While scanning a book, if a page does not need to be scanned, or a page to be scanned is empty, the next page to be scanned can be manually reset to either a left page or a right page by using a page conversion button or key.

While the present invention has been particularly shown and described with reference to exemplary embodiments thereof, it will be understood by those of ordinary skill in the art that various changes in form and details may be made therein without departing from the spirit and scope of the invention as defined by the appended claims and their equivalents.

1. An image forming method performed by an image forming apparatus having a scanning function and connected to a host, the image forming method comprising the steps of:
receiving scanned image data from the image forming apparatus and storing the scanned image data;
determining whether a scanned image belongs to a left page or a right page of a book; and
rotating the scanned image and storing the rotated image if the scanned image belongs to the right page.

2. The image forming method of claim 1, further comprising the step of:
determining whether a book scanning mode is activated, wherein if the book scanning mode is activated the rotation is performed, and if the book scanning mode is deactivated the rotation is not performed.

3. The image forming method of claim 1, further comprising the step of setting a start page to the left page or the right page.

4. The image forming method of claim 1, further comprising the step of resetting a next page to be scanned to the left page or the right page.

5. The image forming method of claim 1, further comprising the step of:
automatically setting a next page to be scanned to the left page or the right page based on a current page if the host completes scanning of the current page.

6. An image forming method performed by an image forming apparatus having a scanning function and connected to a host, the image forming method comprising:
scanning an image and storing the scanned image;
determining whether the scanned image belongs to a left page or a right page of a book; and
rotating the scanned image and storing the rotated image if the scanned image belongs to the right page.

7. The image forming method of claim 6, further comprising the step of transmitting the stored image to the host after the rotation is performed.

8. The image forming method of claim 6, further comprising the step of:
determining whether a book scanning mode is activated, wherein if the book scanned mode is activated the rotation is performed, and if the book scanned mode is deactivated the rotation is not performed.

9. The image forming method of claim 6, further comprising the step of setting a start page to the left page or the right page.

10. The image forming method of claim 6, further comprising the step of resetting a next page to be scanned to the left page or the right page.

11. The image forming method of claim 6, further comprising the step of:
automatically setting a next page to be scanned to the left page or the right page based on a current page if the image forming apparatus completes scanning of the current page.

12. A host connected to an image forming apparatus having a scanning function, the host comprising:
a scanner driving unit which receives scanned image data from the image forming apparatus;
a memory unit which stores the scanned image data; and
a control unit which determines whether a scanned image belongs to a left page or a right page of a book, and rotates the scanned image and stores the rotated image in the memory unit if the scanned image belongs to a right page.

13. The host of claim 12, further comprising a user interface unit which determines whether a book scanning mode is activated, wherein the control unit rotates a scanned image of the right page and stores the rotated image of the right page if the book scanning mode is activated.

14. The host of claim 13, wherein the user interface unit comprises a unit to set a start page to the left page or the right page.

15. The host of claim 13, wherein the user interface unit comprises a unit to reset a next page to be scanned to the left page or the right page.

16. The host of claim 13, wherein the user interface unit comprises a display unit that indicates whether a next page to be scanned is the left page or the right page.

17. The host of claim 12, wherein the control unit automatically sets a next page to be scanned to the left page or the right page based on the current page if the host completes scanning of a current page.

18. An image forming apparatus having a scanning function and connected to a host, the image forming apparatus comprising:
a scanning unit which scans an image;
a memory unit which stores scanned image data; and
a control unit which determines whether a scanned image belongs to a left page or a right page of a book and rotates the scanned image and stores the rotated image in the memory unit if the scanned image belongs to the right page.

19. The image forming apparatus of claim 18, wherein the apparatus further transmits the stored image to the host.

20. The image forming apparatus of claim 18, further comprising a user interface unit which determines whether a book scanning mode is activated, wherein the control unit rotates a scanned image of the right page and stores the rotated image of the right page if the book scanning mode is activated.

21. The image forming apparatus of claim 20, wherein the user interface unit comprises a unit to set a start page to the left page or the right page.

22. The image forming apparatus of claim 20, wherein the user interface unit comprises a unit to reset a next page to be scanned to the left page or the right page.

23. The image forming apparatus of claim 20, wherein the user interface unit comprises a display unit that indicates whether a next page to be scanned belongs to a left page or a right page.

24. The image forming apparatus of claim 18, wherein the control unit automatically sets a next page to be scanned to the left page or the right page based on the current page if the image forming apparatus completes scanning of a current page.

25. The image forming method of claim 2, further comprising the step of setting a start page to the left page or the right page.

26. The image forming method of claim 2, further comprising the step of resetting a next page to be scanned to the left page or the right page.

27. The image forming method of claim 2, further comprising the step of:
automatically setting a next page to be scanned to the left page or the right page based on a current page if the host completes scanning of the current page.

28. The image forming method of claim 7, further comprising the step of:
determining whether a book scanning mode is activated, wherein if the book scanned mode is activated the rotation is performed, and if the book scanned mode is deactivated the rotation is not performed.

29. The image forming method of claim 7, further comprising the step of setting a start page to the left page or the right page.

30. The image forming method of claim 7, further comprising the step of resetting a next page to be scanned to the left page or the right page.

31. The image forming method of claim 7, further comprising the step of:
automatically setting a next page to be scanned to the left page or the right page based on a current page if the image forming apparatus completes scanning of the current page.

32. The host of claim 13, wherein the control unit automatically sets a next page to be scanned to the left page or the right page based on the current page if the host completes scanning of a current page.

33. The image forming apparatus of claim 19, further comprising a user interface unit which determines whether a book scanning mode is activated, wherein the control unit rotates a scanned image of the right page and stores the rotated image of the right page if the book scanning mode is activated.

34. The image forming apparatus of claim 19, wherein the control unit automatically sets a next page to be scanned to the left page or the right page based on the current page if the image forming apparatus completes scanning of a current page.

35. The image forming method of claim 1, wherein the scanned image is rotated substantially 180°.

36. The image forming method of claim 6, wherein the scanned image is rotated substantially 180°.

37. The host of claim 12, wherein the scanned image is rotated substantially 1800.

38. The image forming apparatus of claim 18, wherein the scanned image is rotated substantially 180°.
